(19) United States
(12) Patent Application Publication
(10) Pub. No.: US 2022/0370899 A1
(43) Pub. Date: Nov. 24, 2022

(54) New-generation TV and an operational method for its gaming system integrated with a smartphone

(71) Applicant: YEN-HO LU, Taichung (TW)

(72) Inventor: YEN-HO LU, Taichung (TW)

(21) Appl. No.: 17/327,789

(22) Filed: May 24, 2021

(51) Int. Cl. A63F 13/327; A63F 13/2145; A63F 13/25

(52) U.S. Cl. CPC A63F 13/327; A63F 13/2145; A63F 13/25

(57) ABSTRACT

The invention, a new-generation TV and an operational method for its gaming system integrated with a smartphone, is intended to solve the time lag problem that prior art encounters. The main feature is that the TV is powerful in processing signals and performs as main platform providing signal processing and display, and the smartphone mainly perform as a controller. With the smartphone-connecting mechanism of the TV and the TV-connecting mechanism of the smartphone communicating to each other wirelessly, the TV and the smartphone are connected. The smartphone transmit signals to TV. The TV processes the signals received, and reflects corresponding actions to its screen.

### BACKGROUND OF THE INVENTION

A traditional TV is just a terminal of display, which is not really equipped with CPU (Central Processing Unit) and storage unit like a computer, thus can not be powerful in functions. Compared to TV's screen, on the other hand, a smartphone's screen is too small to be comfortable for playing games. While currently there is related electronic device that can mirror smartphone screen onto TV screen, the mirroring process always has time lag due to massive dynamic image transmissions, making it hard for a player to control and enjoy games.

### SUMMARY OF THE INVENTION

The invention, a new-generation TV and an operational method for its gaming system integrated with a smartphone, is intended to solve the problems that the aforementioned prior arts face. Here the TV generally means stand-alone entertaining apparatus that can show entertaining programs with easy operations without computer-related device such as keyboard or mouse. The TV of the invention is meant to be way more powerful in signal processing and in communicating with smartphones than the ones in place, so that it can be a powerful platform of the game system integrated with smartphones. The main technical feature of the invention is that the TV performs as main platform providing signal processing and display, and the smartphone mainly perform as a controller, so that no time lag due to no massive image transmission would happen in such technical framework, and a player can play games by simply looking at the TV's instead of the smartphone's screen, embracing visual comforts with a way bigger screen.

In the invention, the TV comprises computer-like elements, such as computer-level powerful CPU (central processing unit) that plays as the heart of the system, storage unit such as hard disk, operational system software, and smartphone-connecting mechanism that comes from either built-in one or the one further facilitated by extra add-in software/hardware. And other than known hardware and software, the smartphone also has a TV-connecting mechanism that could also come from either built-in one or the one further facilitated by extra add-in software/hardware.

In the very beginning, the game software to be played should be installed and stored in the TV's storage unit, so that later the system can analyzes and process signals by the CPU based on the game software's codes/logics when the game system is activated. With the smartphone-connecting mechanism and the TV-connecting mechanism communicating to each other wirelessly, the TV and the smartphone are connected to form the gaming system. During the connecting process, the system recognizes the hardware and software information of the smartphone so that later the system can render associated controlling information for the player. After the TV and smartphone are connected and the game software is activated, the system would request smartphone for permission for transmitting touch signals to the TV for processing. Then, the system will process the signals, and exercises corresponding actions on the TV's screen.

For games that require more controlling complexity, the system would virtually divide the smartphone's screen into more than two touch panels, and process their signals separately. For another controlling demand, the system may interpret a continuous touch signal, when meeting a pre-programmed condition, as a trace signal and reflects the trace by showing a moving corresponding cursor on the TV screen, so for the player to know his real-time controlling situation/location. The cursor can be also dismissed when the signals meeting another pre-programmed condition.

Since the smartphone's display may not play an important role when a game is running, on the other hand, the system may enable smartphone's screen display to be in a low power consumption state to save power, such as shutting a certain percentage of the smartphone's screen display. Further, the system can request the smartphone for permissions for transmitting physical button and voice signals to the TV for processing in order to enrich controlling methods; On the other hand, the system can accommodate one or a plurality of smartphones at a time for more players in a game.

### DETAILED DESCRIPTION OF THE INVENTION

Take a player playing a whack-a-mole game for example. The invention, a new-generation TV and an operational method for its gaming system integrated with a smartphone, comprises a TV that is equipped with central processing unit, storage unit (CPU), operational system software Android, and factory built-in smartphone-connecting mechanism. And the smartphone has a factory built-in TV-connecting mechanism.

In the very beginning, the game software is installed and stored into the TV's storage unit, so that later the system can analyzes and process signals by the CPU based on the game software's codes/logics when the game software is activated. With the smartphone-connecting mechanism and the TV-connecting mechanism communicating to each other via say Wi-Fi, the TV and the smartphone are connected wirelessly, and the gaming system is thus formed.

When the game software is activated, the system requests the smartphone's touch signals and the volume up and down button signals to be transmitted to the TV for processing. When a touch signal is continuously detected for say over a second, the system then treats the touch signal as a trace signal and starts to reflect the trace by showing a moving corresponding cursor on the TV screen so for the player to know his real-time controlling situation. The cursor can be dismissed when no touch signal is received for say over a second. More, light and heavy whacking actions are exercised to respectively correspond to the received volume up and down button signals. With the aforementioned, the player can thus comfortably look at the big screen of the TV, and operate the touch panel and volume buttons of the smartphone to play the game.

Alternatively, the volume up and down button signals can be replaced by the voice signals. For example, the system can request the smartphone's voice signals to be transmitted to the TV, and then the system analyzes and exercises light and heavy whacking actions to respectively correspond, by pre-programmed setting, to voices say “pin” and “pon”. On the other hand, the system can accommodate two smartphones as double controllers for two players for competing funs.

Also take recently-famous online game Minecraft for example. In the same fashion, when the TV and smartphone are connected to be a gaming system and the software is activated, the system requests the smartphone's touch signals to be transmitted to the TV for processing. For the touch signals received, the system virtually divides the smartphone's screen in horizontal position into left and right touch panels, and analyzes their touch signals separately. The touch signals detected from the left touch panels will be analyzed and responded by movements of forward/backward/left/right as programmed, and the touch signals detected from the right touch panels will be analyzed and responded by movements of up/down/left-turn/right-turn as programmed. Above responses are shown and reflected on the TV's screen. After the game runs for a predetermined time period, on the other hand, the system demands the smartphone to 100% shut its screen display to save power. With the aforementioned, a player can comfortably play the game with hands controlling the smartphone and eyes looking at the screen of the TV.

In a nutshell, the operational method of the invention comprises following main steps: (please refer to the FIG. 1 for illustration)

First Step 10: with the smartphone-connecting mechanism and the TV-connecting mechanism communicating to each other, and the TV and the smartphone are connected to form the gaming system.

Second Step 20: the system requests the smartphone for permission for transmitting signals to the TV.

Third Step 30: the system analyzes and processes the signals received.

Fourth Step 40: the system determines corresponding actions, and shows them on the TV's screen.

### BRIEF DESCRIPTION OF THE DRAWING

FIG. 1: Main operational steps of the invention

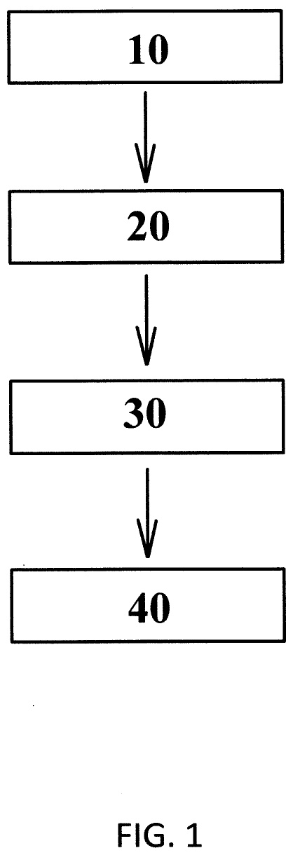

1. A new-generation TV and an operational method for its gaming system integrated with a smartphone; its main feature is that the TV performs as main platform providing signal processing and display, and the smartphone mainly perform as a controller; the TV comprises central processing unit, storage unit, and smartphone-connecting mechanism; the smartphone comprises a TV-connecting mechanism; the game software to be played is installed and stored in the TV's storage unit; and the operation method of the invention comprises following steps:
(a) with the smartphone-connecting mechanism and the TV-connecting mechanism communicating to each other, and the TV and the smartphone are connected to form the gaming system,
(b) the smartphone transmits touch signals to the TV,
(c) the system analyzes and processes the signals received,
(d) the system exercises corresponding actions on the TV's screen.

2. A new-generation TV and an operational method for its gaming system integrated with a smartphone as claim 1, wherein the system can virtually divide the smartphone's screen into more than two touch panels, and analyze their signals separately.

3. A new-generation TV and an operational method for its gaming system integrated with a smartphone as claim 1, wherein the system may interpret a continuous touch signal, when meeting a pre-programmed condition, as a trace signal and reflects the trace by showing a moving corresponding cursor on the TV screen.

4. A new-generation TV and an operational method for its gaming system integrated with a smartphone as claim 1, wherein the system may enable smartphone's screen display to be in a low power consumption state to save power.

5. A new-generation TV and an operational method for its gaming system integrated with a smartphone as claim 1, wherein the system may shut a certain percentage of the smartphone's screen display to save power.

6. A new-generation TV and an operational method for its gaming system integrated with a smartphone as claim 1, wherein the system can request the smartphones for permissions for transmitting physical button signals to the TV side for processing.

7. A new-generation TV and an operational method for its gaming system integrated with a smartphone as claim 1, wherein the system can request the smartphones for permission for transmitting voice signals to the TV side for processing.

8. A new-generation TV and an operational method for its gaming system integrated with a smartphone as claim 1, wherein the system would recognize the hardware and software information of the smartphone.

9. A new-generation TV and an operational method for its gaming system integrated with a smartphone as claim 1, wherein the system can accommodate at least one smartphone at a time.

10. A new-generation TV and an operational method for its gaming system integrated with a smartphone as claim 1, wherein the system can accommodate a plurality of smartphones at a time.
